(19) United States
(12) Patent Application Publication
(10) Pub. No.: US 2007/0077379 A1
(43) Pub. Date: Apr. 5, 2007

(54) Water-assist injection molded structural members

(75) Inventors: Robert J. Passera, Bradford (CA); Martin R. McLeod, Barrie (CA); Bradford D. Armstrong, Barrie (CA)

Correspondence Address: Warn, Hoffmann, Miller & LaLone, P.C., P.O. Box 70098, Rochester Hills, MI, 48307, US

(73) Assignee: Magna International Inc., Aurora (CA)

(21) Appl. No.: 11/239,793

(22) Filed: Sep. 30, 2005

(51) Int. Cl. B32B 27/08

(52) U.S. Cl. 428/35.7; 428/156; 264/572

(57) ABSTRACT

A method of forming members of fiber reinforced thermoplastic members via molding, the members including at least one hollow chamber, formed by water injection into the melt in the mold, to stiffen the finished member. The thermoplastic is preferably selected from a group comprising polypropylene, Nylon, PET, ABS, TPO and thermoplastic polyurethane, while the reinforcing fibers are preferably selected from a group comprising glass, aramid, carbon and natural fibers. Preferably, the extruded melt is produced such that the average length of the reinforcing fibers is longer than the length conventionally obtained.

### FIELD OF THE INVENTION

The present invention relates to injection molded members which can be used as structural members in a vehicle body or the like. More specifically, the present invention relates to long glass fiber reinforced thermoplastic members which include hollow chambers formed via water-assist injection molding and can be used as structural members.

### BACKGROUND OF THE INVENTION

Injection molding of various members used in vehicle bodies and the like is well known. Typically, members are formed from thermoplastic material via injection molding and such members can include single-walled open and/or planar members, such as interior trim pieces, liners for liftgates or tailgates, roof rails, etc.

For single-walled open members or planar members which must bear larger loads, such as running boards, etc., the thermoplastic material is often reinforced with material such as glass fibers, which are added to the thermoplastic melt from which the member is to be molded from.

However, generally such single-walled open members or planar members cannot bear structural loads, even when reinforced with glass fibers in the conventional manner. If such single-walled open members or planar members are required to bear structural loads, for example to support other components attached to them or to support their own attachment to a vehicle, metal inserts to carry the loads must be formed in the molded part or separate reinforcements such as metal plate gussets must be provided.

It is also known to produce hollow members, such as roof rails or the like, using known gas-assist injection molding techniques. While hollow members can provide increased rigidity or other structural load carrying capabilities, it has proven difficult to employ gas-assist injection molding techniques with thermoplastic melts containing reinforcing glass fibers. Members produced with such technology have suffered from irregular wall thickness which often precludes their use as structural members. Further the strength of the fiber-reinforced thermoplastic materials is insufficient for carrying structural loads due to insufficient fiber length and/or poor bonding between the thermoplastic and the fibers.

More recently, water-assist injection molding has been developed. Water assist injection molding is similar to gas assist injection molding with water replacing the gas which is injected into the molten plastic shot in the mold to form one or more hollow cavities within the finished molded part. The greater pressures which can be achieved with water, compared to gas, and the fact that water is incompressible, result in much better wall thickness uniformity than can be achieved with gas assist technologies.

Accordingly, none of the known technologies for injection molding can produce, at a reasonable cost, injection molded members with load carrying capabilities permitting the finished members to be used as structural members.

### SUMMARY OF THE INVENTION

It is an object of the present invention to provide a novel method of manufacturing members from fiber reinforced thermoplastic, via injection molding, which obviates or mitigates at least one disadvantage of the prior art.

According to a first aspect of the present invention, there is provided a method of molding a member capable of carrying light structural loads, comprising the steps of: (i) extruding a shot of a molten thermoplastic material into a mold, the thermoplastic material being reinforced with relatively long length reinforcement fibers; (ii) injecting water into the shot of melt in the mold to form at least one hollow chamber therein, the chamber serving to stiffen the finished structural member; (iii) removing the structural member from the mold and draining the water from the at least one chamber.

Preferably, the thermoplastic material is selected from a group comprising polypropylene, Nylon, PET, ABS, TPO and thermoplastic polyurethane. Also preferably, the reinforcement fibers are selected from a group comprising glass, Aramid, carbon and natural fibers.

The present invention provides a method of forming members of fiber reinforced thermoplastic members via molding, the members including at least one hollow chamber, formed by water injection into the melt in the mold, to stiffen the finished member.

### BRIEF DESCRIPTION OF THE DRAWINGS

Preferred embodiments of the present invention will now be described, by way of example only, with reference to the attached Figures, wherein:

FIGS. 1a, 1b and 1c show three stages in a conventional water-assist injection molding process;

FIG. 2 shows a tailgate manufactured in accordance with the present invention;

FIG. 3 shows the tailgate of FIG. 2 with optional trim panels installed;

FIG. 4 shows an inner view of a liftgate manufactured in accordance with the present invention;

FIG. 5 shows a perspective view of the top and inside of the liftgate of FIG. 4;

FIG. 6 shows a component integration panel manufactured in accordance with the present invention; and

FIG. 7 shows a roof module manufactured in accordance with the present invention.

### DETAILED DESCRIPTION OF THE INVENTION

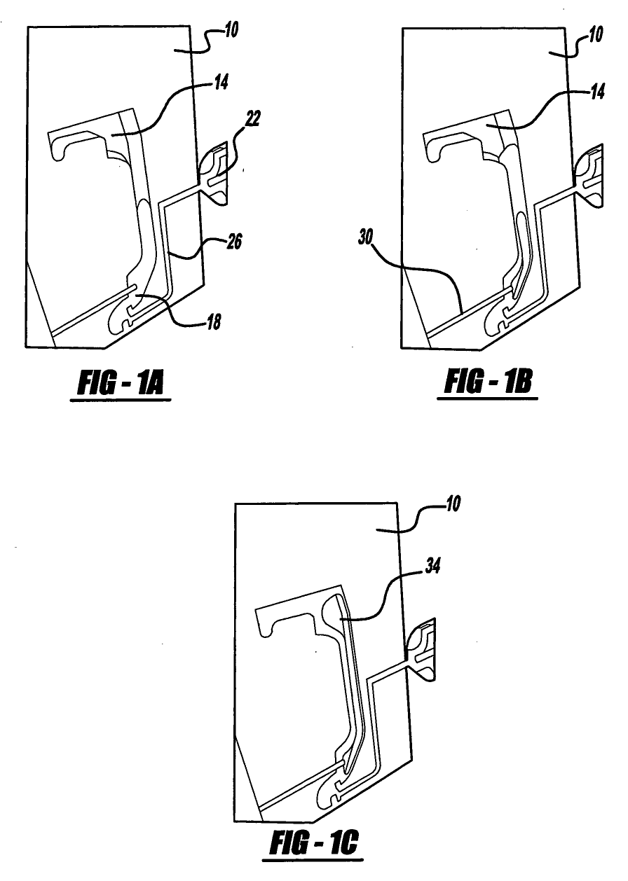

FIGS. 1a through 1c show a water-assist injection molding process in accordance with the present invention. As shown, a mold 10 includes a cavity 14 for a structural member 34 to be molded. In FIG. 1a, cavity 14 receives a measured shot 18 of fiber reinforced thermoplastic material, typically from the nozzle 22 of an extruder (not shown) through a runner or feed passage 26. In FIG. 1b, high pressure water is injected into shot 18 via a water runner 30. Water continues to be injected into shot 18 under pressure, creating a hollow interior cavity in the structural member 34 as shown in FIG. 1c. Using liquid water instead of gas provides several advantages. Water can provide better compression characteristics which will create smoother and more uniform walls in the hollow interior cavity. Water will also shorten production time by assisting in the cooling of the structural member 34.

The shot 18 of fiber reinforced thermoplastic material may be prepared using an extruder with the method and system described in a co-pending U.S. provisional application entitled, Method and System of Compounding Fiber Reinforcing Thermoplastic, to Schrempf, Armstrong and Ranjit, filed on Mar. 3, 2005 and assigned to the assignee of the present invention and the contents of this Schrempf et al. provisional application are incorporated herein by reference.

With the method and system of the Schrempf et al., a melt can be obtained wherein the average length of the glass fibers in the melt produced are 100% longer, or greater, than the length obtained in other processes. The long glass fibers will have a minimum length of 4 mm up to a maximum length of approximately 50 mm. However, fibers having a length range of 35 mm and up provide the best or most ideal melt; fibers 20-34 mm in length yield a better quality melt; and fibers 5-19 mm in length provide a good quality melt. Depending on the particular application the quality of melt may be more important than in other types of applications. Other reinforcement fibers which can be employed with the present invention include aramid, carbon and natural fibers, such as hemp. The typical material composition of the fiber reinforced thermoplastic material will be approximately 40%; however, it is conceivable for the material composition to range from substantially 0% to 50%. The addition of the fiber material yields a fiber reinforced injection molded member capable of carrying light structural loads. The molded member will also exhibit a certain degree of flexibility. In particular the modulus of flexibility of the fiber material is in the range of 500-1000 Kpsi but preferably in the 700-900 Kpsi range. This property adds to the durability and versatility of the molded member. In addition to the fiber material the shot 18 also has thermoplastic material. Preferably, the thermoplastic material is selected from a group comprising polypropylene, Nylon, PET, ABS, TPO and thermoplastic polyurethane.

Due to the increased viscosity of the enhanced-length fiber-reinforced thermoplastic melt which results from the longer fiber length, the injection of water depicted in FIG. 1b, is typically performed at a higher pressure than would conventionally be used to ensure consistent wall thickness of the hollow chambers of the part. After the molded part 34 is removed from the mold, the water can be drained from the chambers either by gravity, application of air pressure, or application of a vacuum.

The structural member 34 that is produced from the process described above will have several unique features and can take many forms. The structural member 34 is a flexible body formed of the fiber reinforced polymeric material. As indicated above the fiber content of the flexible body will range from substantially 0% to 50%. Furthermore, the flexible body will have a modulus of flexibility ranging from 500 1000 kpsi. As indicated above a hollow cavity is formed through the flexible body and as described below will serve many functions. As stated the structural member 34 will take many forms and can be used to form both interior and exterior components. While the situational member is designed to handle light loads, it can be modified to handle heavier loads my placing metal supports within the hollow cavity which will increase the integrity of the structural member. The rest of this section will now focus on some of the specific embodiments of structural members that can be formed using the molding process described above.

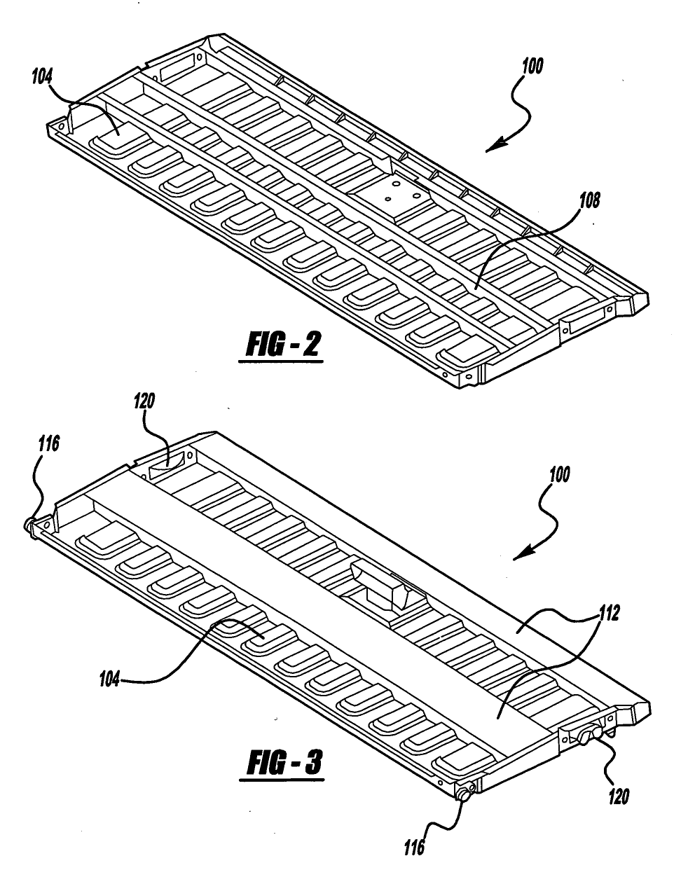

FIGS. 2 and 3 show the molded part as being a tailgate 100 for a pickup truck or the like which has been formed by water-assist injection molding from enhanced-length fiber-reinforced thermoplastic. As shown, tailgate 100 includes a plurality of stiffening chambers 104 and hollow rails 108 which have been formed by water-assist injection molding as described above. Stiffening chambers 104 and hollow rails 108 serve to stiffen tailgate 100 such that it can bear structural loads without significant deformation of tailgate 100.

As shown in FIG. 3, trim panels 112 can be added to the inner and/or outer surfaces of tailgate 100 for cosmetic purposes, to provide the desired outer surface characteristics for tailgate 100. Such trim panels can be attached by any suitable means, such as glue, thermal or sonic welding, metal clips, etc. as will occur to those of skill in the art. Hinges 116 and latches 120 can also be mounted to tailgate 100, which can then be finished by painting, if desired, or tailgate 100 and trim panels 112 can be molded from a melt which includes a colorant to obtain a desired finished color.

If desired, metal inserts can be loaded into the mold when molding tailgate 100 to provide reinforcement for attachment points wherein high stress is expected such as for hinges and/or latches. As will be apparent, tailgate 100 can act as a light duty structural member, bearing hinge loads, body loads and also being able to support some cargo load when in the open (down) position.

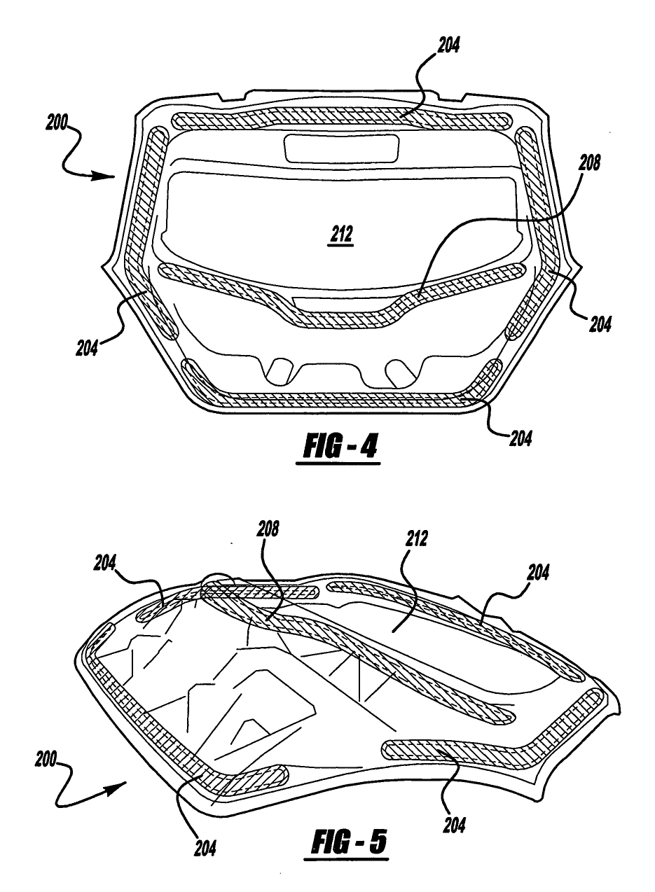

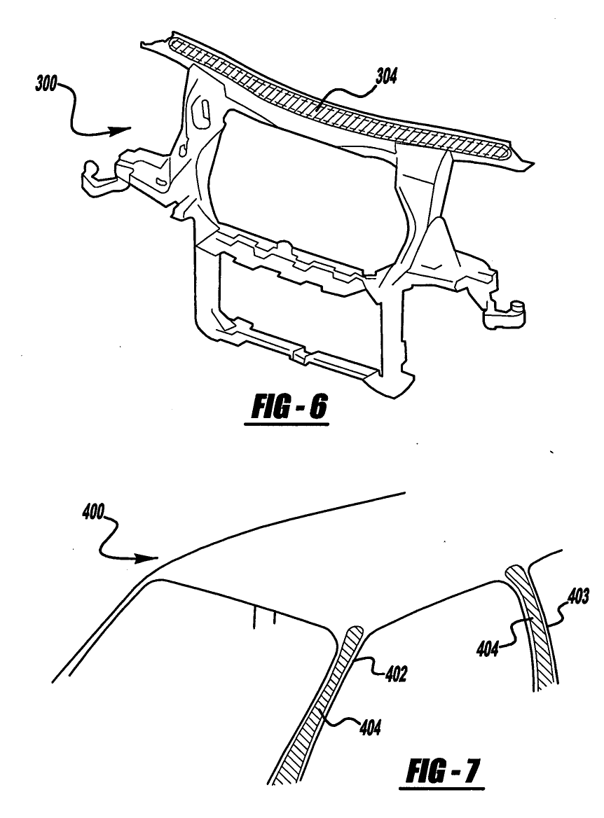

FIGS. 4 and 5 show a liftgate 200, for the rear door of a minivan or the like which has been formed by water-assist injection molding from enhanced-length fiber-reinforced thermoplastic. As shown, liftgate 200 includes a series of stiffening chambers 204 (indicated by hatching) about its periphery and another stiffening chamber 208 (also indicated by hatching) extending across its mid-portion to encircle and structurally strengthen opening 212 for the rear window glass of the vehicle. Stiffening chambers 204 and 208 are formed via injected water, as described above. Liftgate 200 can be completed by attaching inner and outer trim panels, along with the rear window in opening 212 and any mounting hardware, such as hinges or latches.

As it is formed from enhanced-length fiber-reinforced thermoplastic and includes stiffening chambers 204 and 208, liftgate 200 can bear light structural loads and liftgate 200 need not include any metal load bearing members to carry these structural loads. Additionally the stiffening chambers 204 and 208 can be used for wiring purposes, speaker mounts or other components.

FIG. 6 shows a component integration panel structure (CIPS) 300 which has been formed by water-assist injection molding from enhanced-length fiber-reinforced thermoplastic. Conventionally, CIPS are mounted across the front of the engine compartment in a vehicle and serve to connect the left and right sides of the engine compartment, the left and right front fenders. Further, the latch to retain the front edge of the engine compartment hood and headlamp and/or turn signal assemblies can be mounted on a CIPS, as can other subsystems such as air intake plenums, wiring harnesses, etc.

As shown in FIG. 6, CIPS 300 includes a stiffening chamber 304 (indicated by hatching) across its top edge to increase the structural strength of CIPS 300. As will be apparent, additional stiffening chambers 304 can be included in CIPS 300 as needed for different configurations.

FIG. 7 shows another example of a structural member in accordance with the present invention. Specifically, a roof module 400 is illustrated wherein the A and B pillars of roof module 400 include hollow stiffening chambers 404 (indicated by the hatched lines). The A and B pillars with stiffening chambers 404 have the structural load bearing capacity to support a vehicle roof structure and also provide a tubular void that can be used to run electrical or communication wires (overhead lights, DVD player etc.) or for heating or ventilation plenums, or both. A cosmetic outer panel and interior liner can be applied to roof module 400 to finish it.

As should now be apparent, the present invention allows the molding of large members and/or members which are be capable of carrying at least light structural loads such as are experienced by body panels and closures. The members are preferably molded from enhanced-length fiber-reinforced thermoplastic and include one or more hollow features, or chambers, which serve to stiffen the resulting molded member. The chambers are preferably created via the injection of water into the shot of thermoplastic in the mold, in a manner similar to conventional water-assist injection molding techniques.

The above-described embodiments of the invention are intended to be examples of the present invention and alterations and modifications may be effected thereto, by those of skill in the art, without departing from the scope of the invention which is defined solely by the claims appended hereto.

We claim:

1. A method of injection molding a member capable of carrying light structural loads, comprising the steps of:
(i) extruding a shot of a molten thermoplastic material into a mold, the thermoplastic material being reinforced with relatively long length reinforcement fibers;
(ii) injecting water into the shot of melt in the mold to form at least one hollow chamber therein, the chamber serving to stiffen the finished member;
(iii) removing the member from the mold and draining the water from the at least one chamber.

2. The method of claim 1 wherein the reinforcement fibers are glass fibers.

3. The method of claim 2 wherein said glass fibers have a length range of approximately 4 mm to 50 mm.

4. The method of claim 2 wherein said glass fibers have a length range selected from the group consisting of 5-19 mm in length, 20-34 mm in length, or 35-50 mm in length.

5. The method of claim 1 wherein the reinforcement fibers are selected from a group comprising glass, aramid, carbon and natural fibers.

6. The method of claim 1 wherein the thermoplastic material is selected from a group comprising polypropylene, Nylon, PET, ABS, TPO and thermoplastic polyurethane.

7. The method of claim 1 wherein the thermoplastic material has a reinforcement fiber composition of 40% of the total composition of the thermoplastic material.

8. The method of claim 1 wherein the thermoplastic material has a reinforcement fiber composition in a range of 20-40% of the total composition of the thermoplastic material.

9. The method of claim 1 wherein the member has a modulus of flexibility of at least 798 Kpsi,

10. The method of claim 1 wherein the melt is an enhanced-length fiber-reinforced thermoplastic melt.

11. A structural member for a vehicle, comprising:
a body formed by injection molding, the body being formed of thermoplastic material reinforced with fibers of relatively long length and the body including at least one hollow chamber formed via water-assist injection during the molding of the body, the at least one hollow chamber acting to stiffen the finished body.

12. The structural member of claim 11 wherein the member is a tailgate.

13. The structural member of claim 11 wherein the member is a liftgate.

14. The structural member of claim 11 wherein the member is a CIPS.

15. The structural member of claim 11 wherein the member is a roof module.

16. The structural member of claim 11 wherein the member is a roof rail.

17. The structural member of claim 11 wherein the member is a liner for a lift gate or tailgate.

18. The structural member of claim 11 wherein the member is an interior trim piece.

19. The structural member of claim 18 wherein said interior trim piece is selection from a group comprising: a door panel, dash board, or head liner.

20. The structural member of claim 11 wherein the member is a running board.

21. The structural member of claim 11 wherein the member has a modulus of flexibility of at least 798 Kpsi.

22. The structural member of claim 11 wherein said glass fibers of relatively long length are glass fibers having a length range of approximately 4 mm to 50 mm.

23. The structural member of claim 11 wherein said fibers of relatively long length are glass fibers having a length range consisting of 5-19 mm in length, 20-34 mm in length, or 35-50 mm in length.

24. A structural member comprising;
a flexible body formed of a fiber reinforced polymeric material having a fiber content ranging from zero substantially zero to fifty percent, wherein said flexible body has a modulus of flexibility ranging from 500 to 1000 kpsi; and
a hollow cavity formed through at least a portion of said flexible body.

25. The structural member of claim 24 wherein the walls of the cavity are even.

26. The structural member of claim 24 wherein said fiber is glass fibers having a length range of 4 to 50 millimeters.

27. The structural member of claim 24 wherein said fiber is glass fibers having a length range consisting of 5-19 mm in length, 20-34 mm in length, or 35-50 mm in length.

28. The structural member of claim 24 wherein said flexible body is an interior trim piece.

29. The structural member of claim 24 wherein said interior trim piece is a liner for a lift gate, pillar covers, arm rest, door panel, dash board or head liner.

30. The structural member of claim 24 wherein said flexible body is an exterior vehicle component piece.

31. The structural member of claim 24 wherein said exterior vehicle component is a tailgate liner, roof rail, running board, fascia, pillars, roof module or component integration panel.

32. The structural member of claim 24 wherein said fiber material is selected from a group comprised of glass, Aramid, carbon, hemp or natural fibers.

33. The structural member of claim 24 wherein said polymeric material is selected from a group comprising polypropylene, Nylon, PET, ABS, TPO and thermoplastic polyurethane.

34. The structural member of claim 24 further comprising electrical wiring extending through said hollow cavity.

35. The structural member of claim 24 further comprising metal supports extending through said hollow cavity.

36. The structural member of claim 24 wherein said hollow cavity is a heating or ventilation plenum.
